(19) United States
(12) Patent Application Publication
(10) Pub. No.: US 2011/0204623 A1
(43) Pub. Date: Aug. 25, 2011

(54) PIPE CONNECTION ARRANGEMENT

(75) Inventors: Georg Weick, Plankstadt (DE); Walter Hersel, Leonberg (DE); Uwe Fiedler, Hockenheim (DE); Sebastian Abbott, Heidelberg (DE)

(73) Assignee: TI Automotive (Heidelberg) GmbH, Heidelberg (DE)

(21) Appl. No.: 13/030,285

(22) Filed: Feb. 18, 2011

(30) Foreign Application Priority Data
Feb. 19, 2010 (EP) 10 001 687.2

(51) Int. Cl. F16L 25/00

(52) U.S. Cl. 285/331

(57) ABSTRACT

A pipe connection arrangement for the connection of pipelines, in particular of motor vehicle pipelines to a connection element, wherein a connection fitting is provided which encompasses the pipeline to be connected in the region of one of its pipeline ends and which, with a front side press surface of a of a rear side surface facing a flange connected to the pipeline end. The flange exhibits a sealing surface on its front side, wherein the sealing surface can be pressed by means of an axial movement of the connection fitting to a contact surface of the connection element or to a second sealing surface of a second flange of a second pipeline, wherein a stop element is arranged between the contact fitting and contact surface of the connection element and wherein this stop element limits or interrupts the axial movement of the connection fitting

### CROSS-REFERENCE TO RELATED APPLICATIONS

This patent application claims priority under 35 U.S.C. §119(a) to a patent application filed in the European Patent Office on Feb. 19, 2010, and assigned application serial No. EP 10 001 687.2, which is incorporated herein in its entirety by reference.

### DESCRIPTION

The invention relates to a pipe connection arrangement for the connection of pipelines, in particular of motor vehicle pipelines to a connection element.

Pipe connection arrangements of the aforementioned named type are basically well known from practice. In the process a flange molded onto a pipeline is pressed against a connection surface of a connection element. The clamping pressure required for this purpose is applied with a connection fitting which screws into the connection element and lies flat against the rear side of the flange. In the case of the pipe connection arrangements known from practice, a more or less uncontrolled screwing in of the connection fitting frequently leads to an overstress and to damage of the flange impacted by the connection fitting. Also an insufficient pressing can result. As a rule, disadvantageous leakages or material damages are the result.

The invention is based on the technical problem of specifying a pipe connection arrangement of the initially named type which facilitates the simple and secure production of a fluid-tight connection between a pipeline and a connection element and with which the aforementioned disadvantages are avoided.

For the solution of the technical problem the invention teaches a pipe connection arrangement for the connection of pipelines, in particular of motor vehicle pipelines to a connection element, wherein a connection fitting is provided which encompasses the pipeline to be connected in the region of one of its pipeline ends and which, with a front side press surface of a rear side surface facing a flange connected to the pipeline end, wherein the flange exhibits a sealing surface on its front side, wherein the sealing surface can be pressed by means of an axial movement of the connection fitting to a contact surface of the connection element or to a second sealing surface of a second flange of a second pipeline, wherein a stop element is arranged between the contact fitting and contact surface of the connection element and wherein this stop element limits or interrupts the axial movement of the connection fitting. Axial movement of the connection fitting means a movement of the connection fitting in the direction of the longitudinal axis L of the connection fitting.

In accordance with a very preferred embodiment of the invention the stop element is connected to the front side of the connection fitting and in the case of the axial movement of the connection fitting this stop element can come to rest at the connection surface of the connection element. As a result the axial movement of the connection fitting is limited or interrupted. In accordance with another embodiment of the invention the stop element is connected on the connection surface of the connection element. By means of an axial movement of the connection fitting for practical purposes the front side of the connection fitting comes to rest at this stop element of the connection element and as a result the axial movement of the connection fitting is limited or interrupted. In accordance with an additional embodiment of the invention the stop element is arranged as a separate stop element between the connection fitting and connection surface. In the case of the separate stop element it is in particular a matter of a stop ring which is arranged between the connection fitting and connection surface. This stop ring then limits or interrupts the axial movement of the connection fitting.

In accordance with an especially preferred embodiment of the invention the connection fitting lies in assembled state of the pipe connection arrangement with its front side press surface on the rear-side rear side surface of the flange or directly on it. According to an additional preferred embodiment the stop element or a portion of the stop element is arranged in assembled state of the pipe connection arrangement between the front side press surface of the connection fitting and the rear side surface of the flange. For practical purposes the stop element is then constructed as a separate stop element. In the case of this embodiment the front side press surface of the connection fitting preferably lies against the stop element and preferably the rear side surface of the flange lies on the stop element.

Another embodiment of the invention is characterized in that the stop element is connected to the pipeline and in particular encompasses the pipeline between the connection fitting and the rear side surface of the flange. Hereinafter reference will be made above all to the embodiment in which case the stop element is connected to the front side of the connection fitting and in which case the axial movement of the connection fitting can come to rest at the connection surface of the connection element.

It lies within the scope of the invention that the pipeline connected to the connection fitting on the connection element is brought in connection or in fluid-conducting connection with an additional pipeline. This additional pipeline is in accordance with one embodiment integrated as a pipeline section in the connection element and runs for practical purposes into the connection surface of the connection element. In accordance with another embodiment the additional pipeline is likewise connected as a second separate pipeline to the connection element, so that by means of the connection element a fluid-conducting connection is established between these two pipelines. In this case the first sealing surface of the first flange of the first pipeline is pressed onto the second sealing surface of the second flange of the second pipeline by means of the axial movement of the connection fitting. The rear side surface of the second flange then lies for practical purposes on the connection surface of the connection element.

Preferably the connection fitting exhibits a receiving channel for the pipeline, said receiving channel preferably being designed cylindrical. It lies within the scope of the invention that the flange is formed as a metallic flange by means of cold forming of the pipeline end. In accordance with a preferred embodiment the pipeline and/or the flange are for the most part made of steel. It goes without saying that the flange possesses a greater diameter than the remaining pipeline.

The fact that the sealing surface can be pressed onto the connection surface by means of the axial movement of the connection fitting means within the scope of the invention in particular that the connection fitting can be moved in longitudinal direction of the pipeline to be connected to the connection element. Through the axial movement the sealing surface of the flange is pressed fluid-tightly against the connection surface of the connection element. The inventive stop element ensures that a further increase of the contact pressure by the connection fitting on the flange is avoided when the stop element in assembled state of the pipe connection arrangement is arranged between the connection fitting and connection element or, in accordance with a preferred embodiment of the invention, as soon as the stop element is in non-positive contact with the connection element.

In accordance with one preferred embodiment of the invention the connection fitting can be moved in axial direction exerting a rotating movement or by means of screwing into the connection element. As recommended, the connection fitting exhibits an external thread and the connection element exhibits an internal thread complementary to the external thread. It lies within the scope of the invention that the connection fitting can be screwed into the connection element until according to a preferred embodiment the stop element lies non-positively on the connection surface and prevents a further screwing and displacement of the connection fitting in axial direction or longitudinal direction of the pipeline or of the receiving channel.

To bring about the assembled state the connection fitting is preferably screwed into the connection element so that the press surface of the connection fitting is pushed forward in the direction of the contact surface of the stop element. In the case of screwing in the connection fitting the press surface is brought into contact with the rear side surface of the flange so that the sealing surface of the flange is pressed fluid-tightly against the connection surface of the connection element and the flange is preferably finally deformed or elastically deformed. It lies within the scope of the invention that in this manner a connection is established between the pipeline connected to the connection fitting and the further pipeline. By means of the insertion or screwing in of the connection fitting to the connection element in accordance with a preferred embodiment the stop element comes to rest on the connection surface, so that a further pushing forward or screwing in of the connection fitting in the connection element as well as a further deforming of the flange is no longer possible.

It is possible that the connection fitting and/or the connection element are provided with a coating at least in regions and preferably completely.

For example a galvanic coating and/or a lubricant can be provided as a coating on the connection fitting and/or on the connection element.

In accordance with one embodiment the stop element extends at least over a front side peripheral section of the connection fitting. It is also possible that a plurality of stop elements is arranged at the front side of the connection fitting. Preferably the at least one stop element is connected in one piece or molded on to the connection fitting.

In one preferred embodiment the stop element is annular in design or for the most part annular and surrounds the press surface of the connection fitting either completely or for the most part completely. It lies within the scope of the invention that the press surface is oriented transverse or perpendicular to the longitudinal axis of the connection fitting. In accordance with one embodiment of the connection fitting the press surface is arranged at an angle to the longitudinal axis of the connection fitting or to the longitudinal axis of the receiving channel. In a further embodiment of the connection fitting the press surface is constructed in a spherical shell shape. It lies within the scope of the invention that the rear side surface of the flange is designed complementary to the press surface of the connection fitting.

It lies in addition within the scope of the invention that the annular stop element is constructed as a collar shaped hollow cylinder section enclosing the press surface. Empohlenermassen the stop element exhibits in (not yet) assembled state of the pipe connection arrangement a maximum axial length which is smaller than or little smaller than the axial length of the flange. Axial length here means the expanse of the stop element or of the flange in longitudinal direction of the connection fitting or of the pipeline to be connected.

In the case of the assembly of the connection fitting to the connection element or in the case of the screwing of the connection fitting into the connection element the front side press surface of the connection fitting meets the rear side surface of the flange and impacts the flange with pressure. In the case of further insertion or screwing in of the connection fitting the flange is elastically deformed. In the case of further action of the front side press surface on the rear side surface of the flange the flange is finally plastically deformed after the elastic deformation. For practical purposes, within the scope of the invention an excessive plastic deformation of the flange, which leads to a material damage, should be prevented or extensively reduced. As a result of the fact that the stop element in the case of further insertion or screwing in of the connection fitting in accordance with one preferred embodiment comes to rest on the connection surface of the connection element, a further impact or application of pressure of the flange is prevented, so that As recommended, there is no plastic deformation of the flange or no excessive material damaging plastic deformation of the flange. In accordance with one embodiment of the inventive connection arrangement the axial length of the stop element is measured provided that that the flange is only elastically deformed when the stop element comes to rest on the connection surface. The extent of the contact pressure which the press surface of the connection fitting exerts on the rear side surface of the flange when being assembled can be adjusted by the axial length of the stop element and/or the axial length of the flange. For example an enlargement of the axial length of the stop element causes a decrease of the contact pressure if the axial length of the flange remains unchanged. An excessive plastic deformation of the flange is for practical purposes prevented or excluded by means of the adjustment of the axial length of the stop element.

As recommended, at least a section of the rear side surface of the flange lies on the press surface of the connection fitting when, in accordance with a preferred embodiment the stop element comes to rest on the connection surface and the sealing surface of the flange is pressed to the connection surface of the connection element. Preferably the rear side surface of the flange lies above the entire periphery of the flange or for the most part over the entire periphery of the flange positively and for practical purposes non-positively on the press surface.

In accordance with an advantageous embodiment of the invention the flange lies in assembled state of the pipe connection arrangement at least over a peripheral section and preferably completely on an inner surface of the annular stop element. As recommended, in the case of assembly an elastic deformation takes place provided that the flange in assembled state is in positive and/or non-positive contact on the inner surface of the annular stop element.

In accordance with a preferred embodiment the flange exhibits on its front side a conical sealing surface. Preferably the connection element exhibits a conical connection surface for positive attachment of the flange. For practical purposes the sealing surface is constructed complementarily conical to the connection surface of the connection element. As recommended, in not yet completely assembled state the angle formed by the conical connection surface and the longitudinal axis of the receiving channel or of the longitudinal axis of the pipeline is greater than the angle formed by the conical sealing surface of the flange and of the longitudinal axis of the receiving channel or of the longitudinal axis of the pipeline. It lies within the scope of the invention that the angle between the conical connection surface and the longitudinal axis of the pipeline is 20° to 80°, preferably 30° to 70° and especially preferably 60° or about 60°. For practical purposes the angle between the conical sealing surface and the longitudinal axis of the pipeline is 20° to 80°, preferably 30° to 70° and especially preferably 55° to 60°. In principle it is possible that the angle between the conical connection surface and the longitudinal axis of the pipeline and the angle between the conical sealing surface and the longitudinal axis of the pipeline is the same size or about the same size.

In the assembled state of the pipe connection arrangement in accordance with a preferred embodiment a front side contact surface of the stop element lies on the connection surface of the connection element. In accordance with one variant this front side contact surface of the stop element is conical in design and lies in assembled state on the preferably conical connection surface. For practical purposes the contact surface and the connection surface are designed complementarily conical. It lies within the scope of the invention that the angle formed by the contact surface and/or the connection surface with the longitudinal axis of the receiving channel ranges from 15° to 85°, preferably 25° to 75° and especially preferably 55° to 60°.

In accordance with an additional embodiment of the invention the contact surface of the stop element is oriented perpendicular or for the most part perpendicular to the longitudinal axis of the receiving channel, wherein the connection surface exhibits a bearing surface that is oriented perpendicular or for the most part perpendicular to the longitudinal axis of the receiving channel, upon which bearing surface the contact surface of the stop element lies in the assembled state. For practical purposes the bearing surface forms an annular surface region of the connection surface, arranged perpendicular or for the most part perpendicular to the longitudinal axis of the receiving channel.

It lies within the scope of the invention that a second pipeline is connected to the connection element, said pipeline being connected to the first pipeline encompassed by the connection fitting by means of the pipe connection arrangement. In accordance with one embodiment a pipeline section is integrated into the connection element, said pipeline section connecting the connection surface for the first pipeline to a second connection surface for the second pipeline.

For practical purposes, a second flange with a second sealing surface is molded onto one pipe end of the second pipeline, said second flange being pressed with a second connection fitting against the second connection surface of the connection element provided that the second sealing surface of the second flange is fluid-tight on the additional connection surface. The design of the second connection fitting corresponds in a preferred embodiment to the design of the first connection fitting. It is advisable to push forward the second connection fitting in axial direction or in axial direction of the second pipeline in the direction of the second connection surface and preferably screw it into the connection element, as a result of which the rear side of the second flange is impacted with a contact pressure so that the second sealing surface of the second flange is pressed against the second contact surface and the second flange, as recommended, is essentially elastically deformed and at least excessive plastic deformations are avoided. Preferably the pushing forward or screwing in of the second connection fitting is possible until a second stop element of the second connection fitting is for practical purposes in non-positive contact with the second connection surface and prevents a further displacement of the second connection fitting. Preferably, as a result of this an excessive plastic deformation of the second flange is excluded. As a result a fluid-tight connection is established between the first pipeline to the second pipeline via the pipeline section preferably integrated into the connection element.

In accordance with another embodiment of the invention a connection is established between a first and second pipeline by means of only one connection fitting. In the process the connection fitting encompasses the first pipeline to be connected and in assembled state the front side press surface of the connection fitting lies on the rear side surface of the flange of the first pipeline. The second pipeline exhibits a second flange on its pipeline end. In assembled state the second pipeline passes through the connection element and the second flange lies with its rear side surface on the connection surface of the connection element. In this assembled state the first flange or the sealing surface of the first flange is pressed onto the second flange or the sealing surface of the second flange by the connection fitting. The connection fitting impacts both adjacent flanges with force and in the process, the rear side surface of the second flange is pressed onto the connection surface. The insertion or screwing in of the connection fitting is also limited or interrupted in the case of this embodiment preferably by the stop element connected to the connection fitting and to be brought into contact with the connection surface of the connection element. In the assembled state the stop element for practical purposes encompasses both the first flange as well as the second flange abutting the first flange. For practical purposes the second sealing surface of the second flange is constructed complementarily to the sealing surface of the first flange. In accordance with an especially preferred embodiment the axial length of the stop element is measured provided that the first flange and/or the second flange in the case of insertion or screwing in of the connection fitting is essentially elastically deformed and at least an excessive plastic deformation is avoided.

Preferably the flange molded onto the first pipeline and/or the second pipeline is an E flange or an F flange. As recommended, a flange complementary to the flange of the first pipeline is molded onto the second pipeline. For example an F flange is molded onto the first pipeline and an E flange is molded onto the second pipeline.

It lies within the scope of the invention that the internal thread of the connection element is arranged in a blind hole in the connection element. It is possible that the connection element is constructed as a nut, into which the connection fitting can be screwed to produce the assembled state of the pipe connection arrangement.

The invention is based on the knowledge that with the inventive pipe connection arrangement a connection can be established between a pipeline and a connection element or a second pipeline in simple fashion, wherein leakages of the pipeline connection can be prevented in function reliable manner. The invention is based in particular on the knowledge that in the case of the insertion or screwing in of the connection fitting and in the case of the pressing of the connection fitting on the flange of the pipeline for an optimum sealing effect an elastic deformation of the flange can be allowed, while an excessive plastic deformation of the flange is prevented, in order to exclude damages and leaks of the pipeline connection. On the basis of the inventive stop element this optimum sealing effect can be achieved surprisingly easily and effectively. In particular in the case of the use of a connection fitting constructed as a screw fitting the stop element prevents an over-tightening of the connection fitting, so that an excessive plastic deformation of the flange is reliably prevented. As a result the inventive pipe connection arrangement stands out not only due to a reliable installability, but rather also due to a high operational security. It is essential to the invention that due to the design of the inventively provided stop element a flange is elastically deformed in precisely adjustable manner, as a result of which the contact pressure of the flange against a connection surface is optimally adjustable. In the process the inventive design of the stop element prevents a plastic deformation causing the destruction of the flange, even when the connection fitting is axially moved due to the action of excessive force or is screwed into the connection element. In addition the invention is based on the knowledge that an inventive pipe connection arrangement can be integrated into existing pipeline systems without problems. Nevertheless the inventive device stands out due to a surprisingly simple structure and offers the aforementioned advantages in comparison with pipe connection arrangements known from practice.

### BRIEF DESCRIPTION OF THE DRAWINGS

In the following the invention will be described more closely with the help of a drawing representing only one exemplary embodiment. The figures show the following in schematic representation:

FIG. 1 shows a cross-section of an inventive pipe connection arrangement in unassembled state in a first embodiment,

FIG. 2 shows a cross-section of an inventive pipe connection arrangement in unassembled state in a second embodiment,

FIG. 3 shows a cross-section of an inventive pipe connection arrangement in unassembled state in a third embodiment,

FIG. 4 shows a cross-section of an inventive pipe connection arrangement in assembled state in the first embodiment,

FIG. 5 shows a cross-section of an inventive pipe connection arrangement in assembled state in a fourth embodiment and

FIG. 6 shows a cross-section of an inventive pipe connection arrangement in assembled state in an additional embodiment.

### DETAILED DESCRIPTION OF THE INVENTION

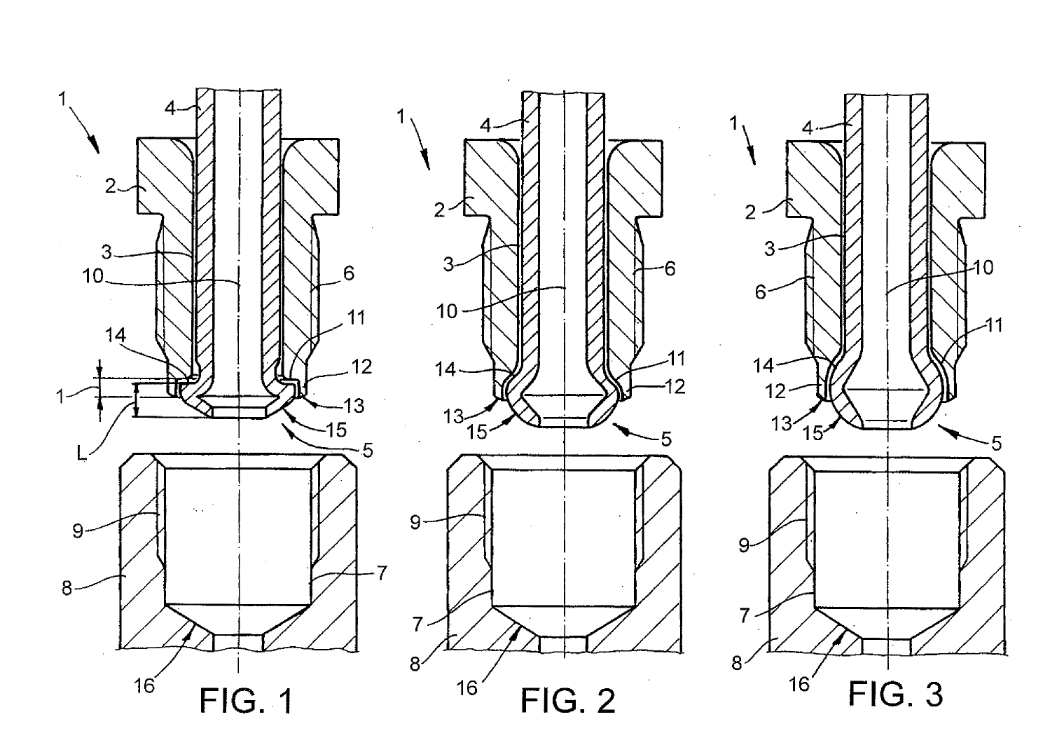

FIGS. 1 through 3 show a pipe connection arrangement I with a connection fitting 2, said connection fitting exhibiting a receiving channel 3 for a pipeline 4. In the exemplary embodiment in accordance with FIGS. 1 through 3 a pipeline 4 with a flange 5 is arranged in the receiving channel 3. The connection fitting 2 exhibits an external thread 6 here, said external thread being screwed into a borehole 7 of a connection element 8 with an internal thread 9. As a result of this screwing in the connection fitting 2 is moved in axial direction or along a longitudinal axis 10 of the pipeline 4 or of the receiving channel 3.

In accordance with the exemplary embodiments according to FIGS. 1 through 3, the connection fitting 2 exhibits a front side press surface 11, from which an annular stop element 12 protrudes and which is encompassed by the annular stop element 12. The annular stop element 12 exhibits in accordance with FIGS. 1 through 3 a front side contact surface 13, which is conical in design. In FIGS. 1 through 3 it can be recognized that the axial length I of the annular stop element 12 in the direction of the longitudinal axis 10 of the receiving channel 3 or of the pipeline 4 in unassembled state of the pipe connection arrangement 1 is smaller than the axial length L of the flange 5 in the direction of the longitudinal axis 10.

FIG. 1 shows an F flange 5 with a rear side surface 14 which is oriented perpendicular to the longitudinal axis 10 of the pipeline 4 and which is annular in design. The rear side surface 14 of the flange 5 in FIG. 2 is oriented at an angle to the longitudinal axis 10 of the pipeline. In accordance with FIG. 3 the rear side surface 14 of the flange 5 is spherical shell-shaped in design. Preferably and in accordance with the exemplary embodiments in FIGS. 1 through 3 the sealing surfaces 15 of the flange 5 are conical in design.

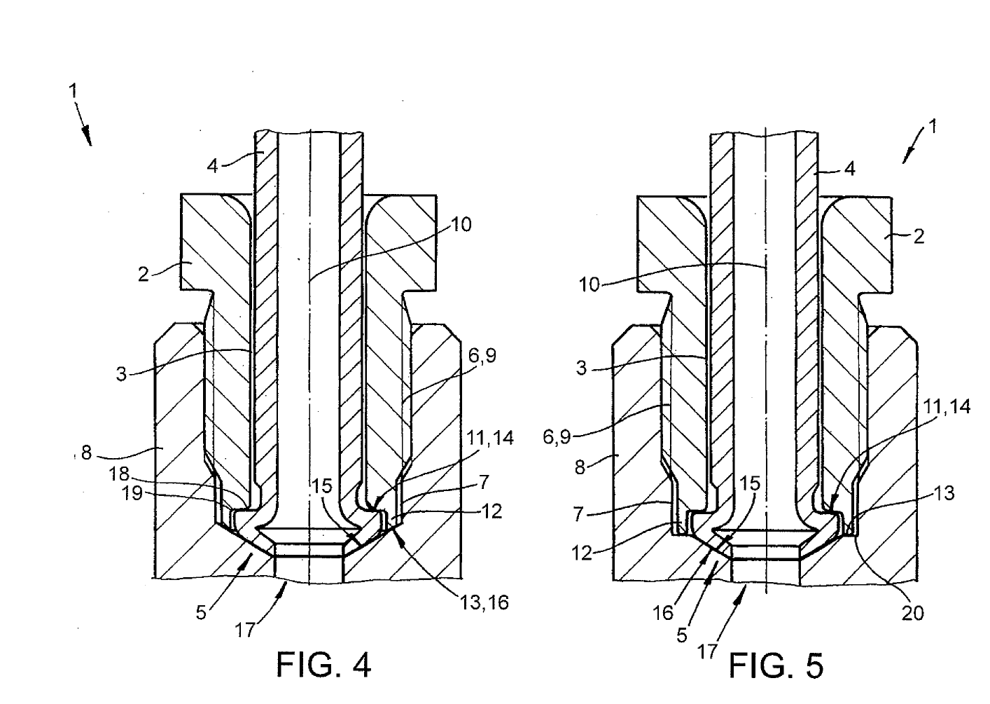

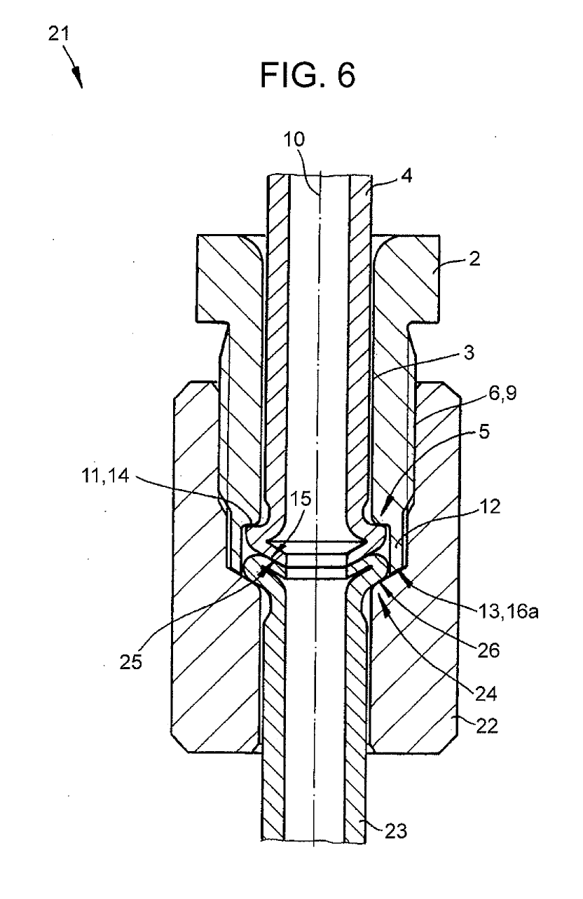

To produce the assembled state the connection fitting 2 is screwed into the borehole 7 of the connection element 8, as a result of which the press surface 11 of the connection fitting 2 comes to rest on the rear side surface 14 of the flange 5. By means of further screwing of the connection fitting 2 into the borehole 7 the sealing surface 15 of the flange 5 is pressed against a connection surface 16 of the connection element 8 and the flange 5 is eventually elastically deformed. The assembled state is achieved when the connection fitting 2 has been screwed into the borehole 7 so far that the stop element 12 lies non-positively on the connection surface 16 of the connection element 8. As a result of this an additional screwing of the connection fitting 2 into the borehole 7 of the connection element 8 is excluded. The assembled state of the pipe connection arrangement 1 is shown in FIGS. 4 and 5.

In the case of the pipe connection arrangements 1 shown in FIGS. 4 and 5 the connection fitting 2 is completely screwed into the borehole 7 of the connection element 8, so that the stop element 12 lies on the connection surface 16. The press surface 11 lies on the rear side surface 14 of the flange 5 and the sealing surface 15 of the flange 5 is pressed against the connection surface 16 of the connection element 8. In the case of screwing the connection fitting in the flange 5 is elastically deformed, so that the sealing surface 15 of the flange 5 lies in fluid tight manner on the connection surface 16 of the connection element 8. In accordance with FIGS. 4 and 5 a pipeline section 17 is integrated into the connection element 8, so that in assembled state according to FIGS. 4 and 5 a fluid-tight connection is established between the pipeline 4 and the pipeline section 17.

According to FIG. 4 the contact surface 13 of the annular stop element 12 is conical in design and in assembled state of the pipe connection arrangement 1 lies non-positively and positively on the connection surface 16 of the cone-shaped connection element 8 complementary to the contact surface 13. As a result of this, additional screwing of the connection fitting 2 into the borehole 7 of the connection element 8 is excluded.

In addition FIG. 4 shows that an inner edge 18, which limits the press surface 11 to the receiving channel 3, is rounded in design. Further FIG. 4 shows that an outer edge 19, with which the press surface 11 borders on the annular stop element 2, is rounded in design.

FIG. 5 shows an inventive pipe connection arrangement 1 in a fourth embodiment which differs from the pipe connection arrangement 1 in accordance with the first embodiment in that the contact surface 13 of the connection element 12 is oriented perpendicular to the longitudinal axis 10 of the receiving channel 3. In accordance with FIG. 5 the connection surface 16 of the connection element 8 exhibits an annular bearing surface 20 which is likewise oriented perpendicular to the longitudinal axis 10 of the receiving channel 3 or the pipeline 4 and upon which in assembled state of the pipe connection arrangement 1 the stop element 2 lies.

FIG. 3 shows a pipe connection arrangement 1 which is constructed as a bolted connection or bolted connection device 21 and which facilitates a connection between a first pipeline 4 and a second pipeline 23. The first pipeline 4 exhibits on its pipeline end an F flange 5. In a connection element constructed as a nut 22 the second pipeline 23 is mounted with an E flange 24. The nut 22 exhibits an internal thread 9, into which the connection fitting 1 with the external thread can be screwed. The connection fitting 2 surrounds the first pipeline 4, wherein the press surface 11 of the connection fitting 2 lies on the rear side surface 14 of the F flange 5. A flange connection surface 25 of the E flange 24 is conical in design, wherein the relevant cone tapers inward, i.e. to the side of the pipe. The F flange 5 likewise exhibits a conical sealing surface 15, wherein said cone tapers outward, i.e. to the front end of the pipeline 4. By means of screwing the connection fitting 2 a clamping pressure is exerted on the rear side surface 14 of the F flange 5 via the press surface 11 of the connection fitting 2. As a result of this the sealing surface 15 of the F flange 5 is pressed in fluid-tight manner against the flange connection surface 25 of the E flange 24, whose rear side 26 lies on the connection surface 16a of the nut 11. In assembled state of the bolted connection device 21 the connection fitting 2 is screwed into the nut 22, so that the stop element 12 lies against the connection surface 16a of the nut 22 and prevents a further screwing in of the connection fitting 2 into the nut 22. FIG. 3 does not show that in the assembled state the F flange 5 and the E flange 24 are only elastically deformed. The design of the connection fitting 2 according to FIG. 3 corresponds to the design of the connection fitting 2 in accordance with FIG. 1.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

What is claimed is:

1. A pipe connection arrangement for the connection of a pipeline to a connection element said pipeline having an enlarged flange at an end thereof, said flange having a sealing surface on its front side and a rear side surface, said connection element defining a contact surface, wherein a connection fitting is provided which encompasses the pipeline in the region of said flange, said connection fitting including a front side press surface contacting said rear side surface of said flange of said pipeline, wherein said sealing surface is pressed by axial movement of said connection fitting into contact with said contact surface of said connection element or a second sealing surface of a second flange of a second pipeline, and wherein said connection fitting includes a stop element contacting said contact surface of said connection element and said stop element limits or interrupts the axial movement of said connection fitting; and in the case of the axial movement of the connection fitting said stop element rests at the contact surface of the connection element.

2. A pipe connection arrangement according to claim 1 where said stop element is connected to said contact surface of the connection element and on axial movement of the connection fitting, the front side press surface of the connection fitting comes to rest on the stop element of the connection element and as a result axial movement of the connection fitting is limited.

3. A pipe connection arrangement according to claim 1 wherein the stop element is connected to said front side press surface of said connection element and is arranged between the front side press surface of the connection fitting and the rear side surface of the flange.

4. The pipe connection arrangement according to claim 2, wherein the stop element is arranged between the front side press surface of the connection fitting and the rear side surface of the flange.

5. The pipe connection arrangement according to claim 3, wherein the connection fitting exhibits an external thread and the connection element exhibits an internal thread complementary to the external thread and wherein the connection fitting can be screwed into the connection element.

6. The pipe connection arrangement according to claim 4, wherein the stop element is annular in design and in the assembled state completely encompasses the press surface of the connection fitting.

7. The pipe connection arrangement according to claim 4, wherein the stop element exhibits an axial length which is smaller than the axial length of the flange.

8. The pipe connection arrangement according to claim 7, wherein the axial length of the stop element is measured with the provision that the flange in the assembled state is elastically deformed.

9. The pipe connection arrangement according to claim 4, wherein the flange lies at least over a peripheral section on an inner surface of the annular stop element when in assembled state the sealing surface is pressed against the connection surface.

10. The pipe connection arrangement according to claim 3, wherein the flange exhibits a conical or spherical shell-shaped sealing surface and wherein the connection element exhibits a conical or spherical shell-shaped connection surface for positive reception of the flange.

11. The pipe connection arrangement according to claim 3, wherein said connection surface is conical and a contact surface formed by a front side of the stop element is conical and lies upon conical connection surface when the connection fitting presses the sealing surface against the connection surface.

12. The pipe connection arrangement according to claim 3, wherein a contact surface of the stop element is oriented generally perpendicular to the longitudinal axis of the receiving channel and wherein said connection surface is oriented generally perpendicular to the longitudinal axis of the receiving channel, upon which bearing surface the contact surface of the stop element lies when the connection fitting presses the sealing surface against the connection surface.

13. The pipe connection arrangement according to claim 1, wherein a second pipeline is connected to the connection element.

14. A pipe connection fitting according to claim 3, wherein in the assembled state the external thread of the connection fitting is screwed into a blind hole of the connection element with complementary internal thread.

15. The pipe connection arrangement according to claim 3, wherein the flange of the pipeline is an E flange or an F flange.

16. The pipe connection arrangement according to claim 3, wherein the flange of the second pipeline is an E flange or an F flange.

17. The pipe connection arrangement according to claim 1, wherein said stop surrounds said flange.
